(19) United States
(12) Patent Application Publication
(10) Pub. No.: US 2025/0193843 A1
(43) Pub. Date: Jun. 12, 2025

(54) INFORMATION PROCESSING DEVICE, METHOD, AND INFORMATION PROCESSING DEVICE

(71) Applicant: TOYOTA JIDOSHA KABUSHIKI KAISHA, Toyota-shi (JP)

(72) Inventors: Takamasa HIGUCHI, Chofu-shi (JP); Jing MA, Yokohama-shi (JP); Xiao Shao, Kawasaki-shi (JP); Lei ZHONG, Tokyo (JP)

(73) Assignee: TOYOTA JIDOSHA KABUSHIKI KAISHA, Toyota-shi (JP)

(21) Appl. No.: 18/957,688

(22) Filed: Nov. 23, 2024

(30) Foreign Application Priority Data
Dec. 8, 2023 (JP) 2023-207784

(51) Int. Cl. H04W 64/00; H04W 12/069

(52) U.S. Cl. CPC H04W 64/006; H04W 12/069

(57) ABSTRACT

An information processing device includes a processor configured to: acquire a pair of a first device and a first terminal predicted to move closer to the first device at a distance shorter than a first distance at which communication is possible using a first communication scheme; and transmit, to at least either of the first device and the first terminal, an instruction to execute a second process that is an advance preparation process for a first process to be executed by the communication using the first communication scheme when the first device and the first terminal are closer to each other at the distance shorter than the first distance.

### CROSS-REFERENCE TO RELATED APPLICATION

This application claims priority to Japanese Patent Application No. 2023-207784 filed on Dec. 8, 2023, incorporated herein by reference in its entirety.

### BACKGROUND

### 1. Technical Field

The present disclosure relates to communications between mobile terminals. In particular, the present disclosure relates to an information processing device, a method, and an information processing device.

### 2. Description of Related Art

There is disclosed an in-vehicle communication device that executes uplink connection to another in-vehicle communication device and downlink connection to the other in-vehicle communication device, and includes an authenticator configured to authenticate the other in-vehicle communication device to which the downlink connection is made, thereby establishing wireless connection in a short period (e.g., Japanese Unexamined Patent Application Publication No. 2014-096630 (JP 2014-096630 A)).

### SUMMARY

An object of the present disclosure is to provide an information processing device and a method capable of reducing a period required for a predetermined process to be executed between a first device and a first terminal by communication using a first communication scheme when the first device and the first terminal are close enough to execute the communication using the first communication scheme.

An aspect of the present disclosure is an information processing device including a processor configured to: acquire a pair of a first device and a first terminal predicted to move closer to the first device at a distance shorter than a first distance at which communication is possible using a first communication scheme; and transmit, to at least either of the first device and the first terminal, an instruction to execute a second process that is an advance preparation process for a first process to be executed by the communication using the first communication scheme when the first device and the first terminal are closer to each other at the distance shorter than the first distance.

Another aspect of the present disclosure is a method including: acquiring, by a first computer out of a plurality of computers, a pair of a first device and a first terminal predicted to move closer to the first device at a distance shorter than a first distance at which communication is possible using a first communication scheme; and transmitting, by at least one computer out of the plurality of computers, to at least either of the first device and the first terminal, an instruction to execute a second process that is an advance preparation process for a first process to be executed by the communication using the first communication scheme when the first device and the first terminal are closer to each other at the distance shorter than the first distance.

Another aspect of the present disclosure is an information processing device including a processor configured to: receive a first request for acquisition of a pair of a first device and a first terminal predicted to move closer to the first device at a distance shorter than a first distance at which communication is possible using a first communication scheme; identify the pair based on information on movement of the first device and a plurality of terminals; and transmit information on the identified pair.

According to the present disclosure, it is possible to reduce the period required for the predetermined process to be executed between the first device and the first terminal by the communication using the first communication scheme when the first device and the first terminal are close enough to execute the communication using the first communication scheme.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a system configuration of an arbitration system according to a first embodiment;

FIG. 2 is a diagram showing an example of a hardware configuration of a management server;

FIG. 3 is a diagram showing an example of a functional configuration of the management server;

FIG. 4 is a diagram showing an example of a functional configuration of an in-vehicle device mounted on a vehicle;

FIG. 5 is an example of a flowchart of a process in the management server according to the first embodiment;

FIG. 6 is an example of a flowchart of a process in the vehicle when an instruction to execute an advance preparation process is received;

FIG. 7 is an example of a flowchart of a process for starting vehicle-to-vehicle communication between vehicles;

FIG. 8 is an example of a processing sequence when the arbitration system according to the first embodiment arbitrates an authentication process for vehicle-to-vehicle wireless local area network (LAN) communication;

FIG. 9 is a diagram showing an example of a system configuration of an arbitration system according to a second embodiment;

FIG. 10 is an example of a functional configuration of a network data analytics function (NWDAF) according to the second embodiment;

FIG. 11 is an example of a flowchart of passing prediction in the NWDAF according to the second embodiment;

FIG. 12 is an example of a flowchart of a process in the management server according to the second embodiment;

FIG. 13 is a diagram showing an example of a processing sequence to be executed by an arbitration system according to the second embodiment to arbitrate a predetermined process; and

FIG. 14 is a diagram showing an example of a processing sequence to be executed by an arbitration system according to a third embodiment to arbitrate a predetermined process.

### DETAILED DESCRIPTION OF EMBODIMENTS

In recent years, research has been conducted into technologies that can achieve smooth traffic flow by collecting data from traveling vehicles and analyzing the data collected from the vehicles from various angles. To collect data from vehicles, it is necessary to mount wireless communication devices in the vehicles. However, mobile communication services of Long Term Evolution (LTE) and 5th Generation (5G) onwards have problems in terms of money and cost of wireless bands etc. Therefore, it is conceivable to use vehicle-to-vehicle communication without using the mobile communication services. One type of vehicle-to-vehicle communication is wireless LAN communication.

One of the wireless LAN standards (IEEE 802.11) is IEEE 802.11ai that is a standard for speeding up an authentication process. In IEEE 802.11ai, high-speed negotiation is realized by simplifying sequences of terminal discovery, authentication, and connection in the authentication process.

The IEEE 802.1x standard uses an authentication protocol called “Extensible Authentication Protocol (EAP)” for client authentication. When an access point using EAP is accessed by a client, the access point is authenticated by communicating with an authentication server that manages authentication. Examples of the authentication server include a Remote Authentication Dial-In User Service (RADIUS) server. When authenticated by the authentication server, the port is opened and communication is enabled.

In the IEEE 802.11ai standard, at the time of initial authentication, a re-authentication root key (rRK) acquired in the process of authentication is cached in both the authentication server and the client. In the second authentication onwards, the re-authentication root key can be used to simplify the authentication procedure and reduce delays.

One possible configuration using the authentication conforming to the IEEE 802.11ai standard is a configuration in which the authentication server is disposed on a remote host such as a cloud. In this configuration, when a client vehicle executes initial authentication with the authentication server via any one access point vehicle, the re-authentication root key is cached in the client vehicle and the authentication server. Therefore, when the client vehicle makes connection to another access point vehicle under control of the same authentication server, the authentication procedure can be simplified using the re-authentication root key cached in the client vehicle and the authentication server. In this configuration, however, communication such as cellular communication between the access point vehicle and the authentication server is required each time the client vehicle is authenticated for the second time onwards, resulting in communication overheads and communication delays. When the client vehicle and the access point vehicle are outside the coverage of the cellular network, authentication cannot be executed and vehicle-to-vehicle communication cannot be executed.

Another possible configuration using the authentication conforming to the IEEE 802.11ai standard is a configuration in which an independent authentication server is disposed on an in-vehicle device of every access point vehicle without using the remote host. In this case, authentication of the client vehicle can be executed regardless of the coverage of the cellular network, and vehicle-to-vehicle communication can be executed even outside the coverage of the cellular network. Further, no cellular communication occurs between the access point vehicle and the remote host.

For example, when the client vehicle completes initial authentication with an access point vehicle #A, a re-authentication root key is cached in both the client vehicle and the access point vehicle #A. When the client vehicle moves and makes connection to another access point vehicle #B, however, the authentication process cannot be simplified because the re-authentication root key is not cached in the access point vehicle #B. The client vehicle is required to execute the low-speed initial authentication again.

That is, in the configuration in which the independent authentication server is disposed on the in-vehicle device of every access point vehicle, the authentication procedure can be simplified when the client vehicle makes reconnection to the access point vehicle #A having a history of connection to the client vehicle. Since the client vehicle travels, the client vehicle is unlikely to repeatedly pass the same access point vehicle #A on the road. Therefore, it is difficult for the client vehicle to benefit from the high-speed connection of the IEEE 802.11ai standard.

In view of the above problem, according to one aspect of the present disclosure, a first device and a first terminal predicted to be close to the first device enough to execute communication using a first communication scheme are caused to execute a second process that is an advance preparation process for a first process to be executed by the communication using the first communication scheme before the first device and the first terminal are close enough to execute the communication using the first communication scheme. Since the advance preparation for the first process is completed, the first process can immediately be started when the first device and the first terminal are close enough to execute the communication using the first communication scheme.

More specifically, the one aspect of the present disclosure is an information processing device including a control unit. The control unit acquires a pair of the first device and the first terminal predicted to move closer to the first device at a distance shorter than a first distance at which communication is possible using the first communication scheme, and transmit, to at least either of the first device and the first terminal, an instruction to execute the second process that is the advance preparation process for the first process to be executed by the communication using the first communication scheme when the first device and the first terminal are closer to each other at the distance shorter than the first distance.

The information processing device is a dedicated computer such as a server. The information processing device is not limited to the dedicated computer. The information processing device may be a mobile terminal such as an in-vehicle device, a smartphone, a tablet terminal, or a personal computer (PC). The control unit is a processor such as a central processing unit (CPU), a graphics processing unit (GPU), or a digital signal processor (DSP). The control unit is not limited to the processor, and may be a circuit such as a field-programmable gate array (FPGA), a semiconductor integrated circuit (IC), or a complex programmable logic device (CPLD).

The first communication scheme is a communication scheme capable of terminal-to-terminal communication such as vehicle-to-vehicle wireless LAN communication, dedicated short-range communications (DSRC), or 5G sidelink communication. The first communication scheme is not limited to the terminal-to-terminal communication scheme. When the first communication scheme is wireless LAN communication, the first device may be, for example, a device that operates as an access point. When the first communication scheme is wireless LAN communication, the first terminal may be a terminal that operates as a client to be connected to an access point. The first device and the first terminal may each be a mobile terminal such as an in-vehicle device mounted on a vehicle, a smartphone, a tablet terminal, or a notebook PC. The first device may be, for example, a stationary access point. The first distance is a communication distance of the first communication scheme, and varies depending on which communication scheme corresponds to the first communication scheme.

According to the one aspect of the present disclosure, when the first device and the first terminal are closer to each other at the distance shorter than the first distance, the first device and the first terminal can immediately execute the first process because the second process that is the advance preparation process for the first process has already been executed. Thus, it is possible to reduce the period required for the first process to be executed between the first device and the first terminal by the communication using the first communication scheme after the first device and the first terminal are closer to each other at the distance shorter than the first distance.

In the one aspect of the present disclosure, the first process may be a process in which the first device and the first terminal authenticate, with a predetermined authentication key, connection using the first communication scheme. In this case, the second process may be a process in which the first device and the first terminal each acquire and cache the predetermined authentication key. According to the one aspect of the present disclosure, when the first device and the first terminal are closer to each other at the distance shorter than the first distance, the authentication can quickly be executed using the predetermined authentication key because the first device and the first terminal each cache the predetermined authentication key.

In the one aspect of the present disclosure, the first process may be a process in which one of the first device and the first terminal transmits predetermined data to the other. The data transmission direction may be a downlink direction or an uplink direction. In this case, the second process may be an advance preparation process for transmission of the predetermined data by the one of the first device and the first terminal. The advance preparation process for transmission of the predetermined data is, for example, conversion of the format of the predetermined data into a first format, encoding of the predetermined data, fragmentation of the predetermined data, or download of the predetermined data. The advance preparation process for distribution of the predetermined data is not limited to these. According to the one aspect of the present disclosure, when the first device and the first terminal are closer to each other at the distance shorter than the first distance, one of the first device and the first terminal that will transmit the predetermined data has already been prepared to transmit the data, and can therefore immediately start transmitting the predetermined data to the other.

In the one aspect of the present disclosure, the control unit may acquire information on movement of a plurality of terminals, and acquire the pair of the first device and the first terminal when a distance between the first device and the first terminal is shorter than a second distance longer than the first distance based on the information on the movement of the terminals. Alternatively, the control unit may acquire information on movement of at least the first terminal, calculate a probability that the first device and the first terminal are expected to be closer to each other at the distance shorter than the first distance based on a movement history of at least the first terminal, and identify the pair of the first device and the first terminal when the probability is equal to or higher than a predetermined threshold. Examples of the information on the movement include information indicating the position of the terminal. Examples of the information indicating the position of the terminal include latitude and longitude, and identification information of a tracking area (TA) or cell where the terminal is located. The information on the movement may include, in addition to the information indicating the position of the terminal, for example, a movement speed, a movement history, and an expected movement route and a destination. The information on the movement may be a result of prediction of movement of a vehicle.

Transmission and reception of the information on the movement between the information processing device and the terminals may be executed using a communication scheme different from the first communication scheme. Examples of the communication scheme to be used for the transmission and reception of the information on the movement between the information processing device and the terminals include a cellular communication scheme, IEEE 802.11ah (Wi-Fi HaLow), low power wide area (LPWA), and satellite communication when the information processing device is disposed on a cloud. Examples of the communication scheme to be used for the transmission and reception of the information on the movement between the information processing device and the terminals include Wi-Fi HaLow and cellular device-to-device (D2D) relay communication when the information processing device is disposed in a mobile body such as a vehicle. According to the one aspect of the present disclosure, it is possible to more accurately predict that the first device and the first terminal are closer to each other at the distance shorter than the first distance, and to identify the pair of the first device and the first terminal.

In the one aspect of the present disclosure, the control unit may acquire information on a communication demand from at least the first terminal. In this case, the control unit may identify the pair of the first device and the first terminal based on information on movement of at least the first terminal and the information on the communication demand. Examples of the information on the communication demand include a list of held data, a list of data waiting for download, a list of data waiting for upload, and a requirement for a data aggregation destination. The information on the communication demand is not limited to these. By considering the communication demand of at least either of the first device and the first terminal, the pair can be identified for devices having communication demands. Thus, it is possible to reduce the occurrence of a case where a pair in which communication demands do not match and therefore communication for the first process does not actually occur is identified and causes unnecessary communication and processing for execution of the second process, etc.

In the one aspect of the present disclosure, the control unit may transmit, to a network data analytics function (NWDAF) of a core network of a mobile communication system of 5G onwards, a first request for acquisition of the pair of the first device and the first terminal predicted to move closer to the first device at the distance shorter than the first distance at which the communication is possible using the first communication scheme, and receive the pair from the NWDAF. Alternatively, the control unit may transmit a second request for information on movement of a plurality of terminals to the NWDAF of the core network of the mobile communication system, receive the information on the movement of the terminals from the NWDAF, and identify the pair based on the information on the movement of the terminals.

When the first device and the first terminal are compatible with the mobile communication system, the overhead of the cellular network between each of the first device and the first terminal and the information processing device can be reduced using the NWDAF of the core network of the mobile communication system of 5G onwards.

Another aspect of the present disclosure can be specified as a method including acquiring, by a first computer out of a plurality of computers, a pair of a first device and a first terminal predicted to move closer to the first device at a distance shorter than a first distance at which communication is possible using a first communication scheme, and transmitting, by at least one computer out of the plurality of computers, to at least either of the first device and the first terminal, an instruction to execute a second process that is an advance preparation process for a first process to be executed by the communication using the first communication scheme when the first device and the first terminal are closer to each other at the distance shorter than the first distance.

Another aspect of the present disclosure can be specified as an information processing device including a control unit that receives a first request for acquisition of a pair of a first device and a first terminal predicted to move closer to the first device at a distance shorter than a first distance at which communication is possible using a first communication scheme, identifies the pair based on information on movement of the first device and a plurality of terminals, and transmits information on the identified pair.

Other aspects of the present disclosure can be specified as a method in which a computer executes the process to be executed by the above information processing device, a program for causing a computer to execute the method, and a non-transitory computer-readable recording medium recording the program.

Hereinafter, embodiments of the present disclosure will be described with reference to the drawings. The configurations of the following embodiments are illustrative, and the present disclosure is not limited to the configurations of the embodiments.

### First Embodiment

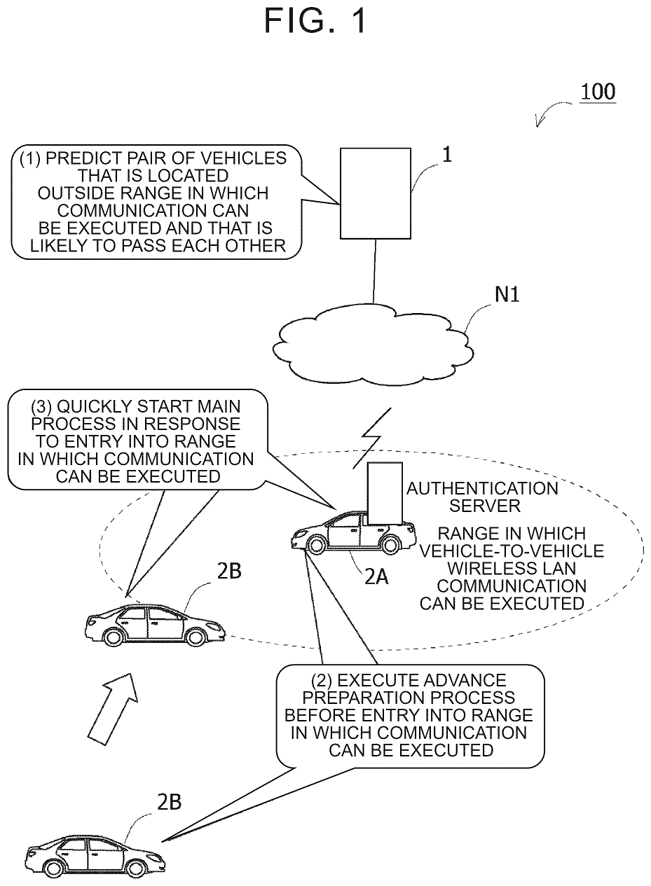

FIG. 1 is a diagram showing an example of a system configuration of an arbitration system 100 according to a first embodiment. The arbitration system 100 arbitrates a predetermined process related to communication between vehicles. The first embodiment illustrates an example in which the arbitration system 100 arbitrates an authentication process conforming to IEEE 802.11ah for vehicle-to-vehicle wireless LAN communication.

The authentication process for vehicle-to-vehicle wireless LAN communication is executed between a client vehicle and an access point vehicle, for example, when the client vehicle makes connection to the Internet via the access point vehicle or when predetermined data is transmitted and received between vehicles. In the authentication process, one acts as an access point and the other acts as a client. Hereinafter, the access point vehicle will simply be referred to as “AP vehicle”. The client vehicle will simply be referred to as “CL vehicle”. In the first embodiment, it is assumed that an authentication server is mounted at least on the AP vehicle.

The arbitration system 100 includes a management server 1, and vehicles 2A and 2B each including an in-vehicle device. The arbitration system 100 includes a plurality of vehicles 2, and the vehicles 2A and 2B are shown as representative vehicles in FIG. 1. When there is no need to distinguish the vehicles, the vehicles will simply be referred to as “vehicles 2”. The vehicle 2 includes an in-vehicle device having a communication function. Although the communication related to the vehicle 2 is actually executed by the in-vehicle device, the following description will be given under the assumption that the communication is executed by the vehicle 2 for convenience.

The management server 1 and each vehicle 2 are connected to a network N1 and can communicate with each other via the network N1. The network N1 is a public network such as the Internet. Each vehicle 2 can be connected to the network N1 via a cellular network or a wireless LAN as an access network.

The vehicle 2 periodically transmits, at a predetermined cycle, movement information on movement of the vehicle 2 and communication demand information on demand for communication to the management server 1 via the network N1.

(1) Based on the movement information and the communication demand information from each vehicle 2, the management server 1 predicts a pair of AP and CL vehicles that has matching communication demands and is likely to pass each other. At this time, the paired AP and CL vehicles are located outside a range in which vehicle-to-vehicle wireless LAN communication can be executed between them. In FIG. 1, it is assumed that the vehicle 2A is the AP vehicle and the vehicle 2B is the CL vehicle. The matching communication demands mean, for example, that data that one is expected to download is included in data held by the other, that one intends to upload data and the other has a sufficient storage capacity to receive the data, or that one is a CL vehicle having a demand to connect to the Internet etc. using wireless LAN communication as an access network and the other is an AP vehicle.

(2) The management server 1 instructs the vehicles 2A and 2B identified as a pair to execute an initial authentication process conforming to the IEEE 802.11ai standard as an advance preparation process. The management server 1 transmits information on the paired vehicle together with the instruction to execute the advance preparation process. Examples of the information on the paired vehicle include an Internet Protocol (IP) address. The information on the paired vehicle is not limited to this.

In the first embodiment, the vehicles 2A and 2B execute the initial authentication process conforming to the IEEE 802.11ai standard based on the instruction from the management server 1. When the initial authentication process conforming to the IEEE 802.11ai standard is executed between the vehicles 2A and 2B, a re-authentication root key is generated during the authentication process and is cached in the vehicles 2A and 2B. That is, the initial authentication process is executed to acquire an authentication key. Therefore, the advance preparation process in the first embodiment can also be expressed as an authentication key acquisition process. In the first embodiment, the vehicle 2A caches the re-authentication root key as the authentication server, and the vehicle 2B caches the re-authentication root key as the client vehicle.

Since the vehicles 2A and 2B are located outside the range in which vehicle-to-vehicle wireless LAN communication can be executed, the initial authentication process is executed using, for example, a cellular network or a vehicle-to-vehicle communication scheme having a longer communication distance than that of the vehicle-to-vehicle wireless LAN communication. Examples of the vehicle-to-vehicle communication scheme having a longer communication distance than that of the vehicle-to-vehicle wireless LAN communication include Wi-Fi HaLow and cellular device-to-device (D2D) relay communication. The management server 1 may or may not be involved in the initial authentication process between the vehicles 2A and 2B.

(3) When the vehicles 2A and 2B approach each other at a distance shorter than the distance required for the vehicle-to-vehicle wireless LAN communication, the authentication key acquisition process has already been executed as the advance preparation process, and the vehicles 2A and 2B therefore execute a main process that is an authentication process using the cached re-authentication root key. With the cached re-authentication root key, the authentication process can be simplified and the vehicles 2A and 2B can quickly be connected to each other. In the first embodiment, the main process is an authentication process using the authentication key.

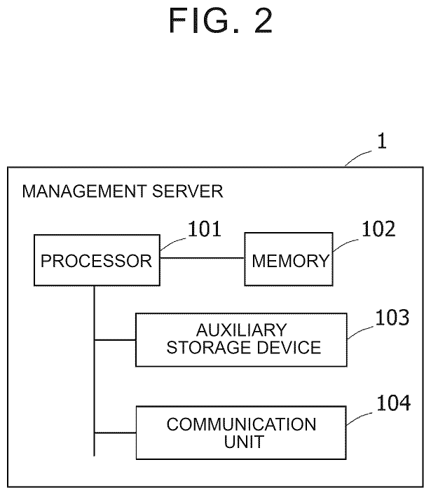

FIG. 2 is a diagram showing an example of a hardware configuration of the management server 1. The management server 1 can be configured using an information processing device (computer) such as a server machine. The management server 1 may be a collection of one or more computers (cloud). The management server 1 may be a device including an electric circuit such as a field-programmable gate array (FPGA) or an application specific integrated circuit (ASIC) dedicated to execute a corresponding process.

The management server 1 includes a processor 101, a memory 102, an auxiliary storage device 103, and a communication unit 104 as the hardware configuration. The memory 102 and the auxiliary storage device 103 are computer-readable recording media. The processor 101, the auxiliary storage device 103, and the communication unit 104 are electrically connected to each other by a bus.

The auxiliary storage device 103 stores various programs and data to be used by the processor 101 to execute the programs. Examples of the auxiliary storage device 103 include an erasable programmable read only memory (EPROM), a hard disk drive (HDD), and a solid state drive (SSD). Examples of the programs held in the auxiliary storage device 103 include an operating system (OS) and a control program for the arbitration system 100.

The memory 102 is a storage device that provides the processor 101 with a storage area and a working area for loading the programs stored in the auxiliary storage device 103 and that is used as a buffer. The memory 102 includes a semiconductor memory such as a read only memory (ROM) and a random access memory (RAM).

The processor 101 executes processes by loading the OS and the control program for the arbitration system 100 held in the auxiliary storage device 103 into the memory 102 and executing them. Examples of the processor 101 include a central processing unit (CPU), a graphics processing unit (GPU), and a digital signal processor (DSP). The number of processors 101 is not limited to one, and a plurality of processors may be provided. The processor 101 is an example of a “control unit”.

Examples of the communication unit 104 include a network interface card (NIC) and an optical line interface. The communication unit 104 may be, for example, a wireless communication circuit connected to a wireless network such as a wireless LAN. The hardware configuration of the management server 1 is not limited to that shown in FIG. 2.

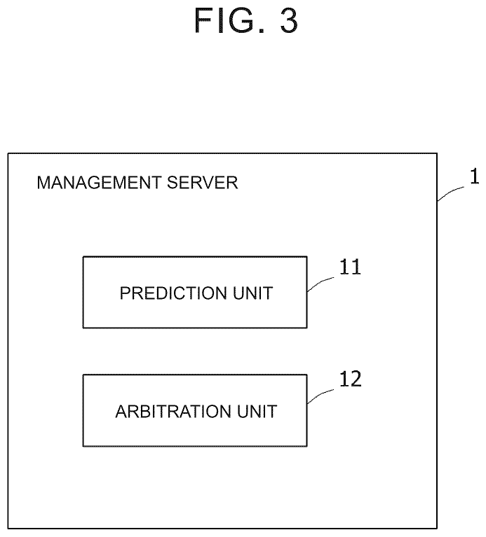

FIG. 3 is a diagram showing an example of a functional configuration of the management server 1. The management server 1 includes a prediction unit 11 and an arbitration unit 12 as the functional configuration. The prediction unit 11 and the arbitration unit 12 are functional components that are implemented, for example, by the processor 101 of the management server 1 executing the control program for the arbitration system 100. The present disclosure is not limited to this, and the prediction unit 11 and the arbitration unit 12 may each be implemented by a hardware component such as an FPGA.

In the first embodiment, the prediction unit 11 receives movement information and communication demand information from each vehicle 2 periodically at the predetermined cycle. The prediction unit 11 executes passing prediction, communication demand determination, and pair requirement determination. The passing prediction involves predicting, based on the movement information of each vehicle 2, a pair of vehicles 2 that is likely to pass each other within a predetermined period in the future, that is, likely to approach each other at a distance shorter than the distance required for the vehicle-to-vehicle wireless LAN communication. The communication demand determination is to identify a pair of vehicles 2 having matching communication demands based on the communication demand information of each vehicle 2.

The pair requirement determination is to identify a pair of vehicles 2 that meets a requirement according to a process to be arbitrated by the arbitration system 100. In the first embodiment, the arbitration system 100 arbitrates an authentication process for vehicle-to-vehicle wireless LAN communication. Therefore, the pair requirement is that the AP vehicle and the CL vehicle are paired. The assignment of roles of the AP vehicle and the CL vehicle is determined in advance by a predetermined method based on, for example, the specifications of the vehicles 2 and the density of the vehicles 2, and the prediction unit 11 grasps the roles of the vehicles 2 in advance. Details of the passing prediction and the communication demand determination will be described later.

In the first embodiment, through the passing prediction, the communication demand determination, and the pair requirement determination, the prediction unit 11 identifies a pair of AP and CL vehicles that has matching communication demands and is predicted to approach each other at a distance shorter than the distance required for the vehicle-to-vehicle wireless LAN communication within the predetermined period in the future. The prediction unit 11 notifies the arbitration unit 12 about the identified pair of vehicles 2.

When the arbitration unit 12 receives the notification about the pair of vehicles 2 from the prediction unit 11, the arbitration unit 12 transmits an instruction to each of the vehicles 2 to execute the advance preparation process. For example, information on the paired vehicle 2 and information to be used in the advance preparation process are transmitted together with the instruction to execute the advance preparation process. Examples of the information on the paired vehicle 2 include an IP address of the paired vehicle 2. Examples of the information to be used in the advance preparation process include a service set identifier (SSID) to be used for authentication when the advance preparation process is the authentication key acquisition process (initial authentication process). The instruction to execute the advance preparation process is transmitted, for example, via a cellular network. The arbitration unit 12 may or may not be involved in the authentication key acquisition process as the advance preparation process in the first embodiment, for example by mediating communication between the paired vehicles 2.

### Passing Prediction

The passing prediction by the prediction unit 11 will be described. The passing prediction is executed based on pieces of movement information from the vehicles 2. The movement information from the vehicle 2 includes, for example, position information and a speed of the vehicle 2. The movement information may include movement history information of the vehicle 2, and an expected movement route and a destination set in a car navigation system. Examples of the movement history information include combinations of timestamps and position information of the vehicle 2 at the times indicated by the timestamps in a predetermined period immediately preceding a current time. The information included in the movement history information is not limited to these pieces of information. The prediction unit 11 may improve the accuracy of the passing prediction using, in addition to the movement information from the vehicle 2, information provided by external organizations, such as a congestion status of each road link and origin-destination (OD) traffic volume statistical information derived from the past vehicle movement history.

The prediction unit 11 predicts the movement trajectory of each vehicle 2 within the predetermined period in the future based on the movement information etc., and determines a pair of vehicles 2 that is likely to pass each other within the predetermined period in the future. Examples of the passing prediction method for determining the pair of vehicles 2 that is likely to pass each other include the following methods. The prediction unit 11 may employ any of the following methods. The passing prediction method to be employed by the prediction unit 11 is not limited to the following methods.

### Passing Prediction Method 1

This is a method for making determination based on current positions of the vehicles 2. When the distance between current positions of two vehicles 2 is smaller than a predetermined threshold, the prediction unit 11 determines that the two vehicles 2 are likely to pass each other within the predetermined period in the future. The threshold depends on the type of employed vehicle-to-vehicle communication. In the case of vehicle-to-vehicle wireless LAN communication, the threshold is, for example, 300 meters to 500 meters.

### Passing Prediction Method 2

This is a method for filtering pairs of vehicles 2 predicted by passing prediction method 1 in consideration of additional information such as a relative speed of two vehicles 2 and a road link where they are traveling. For example, when the distance between two vehicles 2 is increasing over time or when it is presumed that the two vehicles 2 are unlikely to pass each other based on a connection relationship between road links where the two vehicles 2 are traveling, the prediction unit 11 excludes the two vehicles 2 from pairs of vehicles 2 that are likely to pass each other even if the distance between the two vehicles 2 is smaller than the predetermined threshold.

### Passing Prediction Method 3

This is a method for predicting movement routes of the vehicles 2 based on route information from a car navigation function and the past vehicle movement history, calculates the probability that two vehicles 2 will pass each other on their movement routes, and makes determination based on this probability. The method for predicting the movement routes of the vehicles 2 and the method for calculating the probability that two vehicles 2 will pass each other on their movement routes may be any known methods using, for example, predetermined algorithms or machine learning models. When the probability of passing each other is equal to or higher than a predetermined threshold, the prediction unit 11 determines that the two vehicles 2 are a pair of vehicles 2 that is likely to pass each other.

### Communication Demand Determination

The pair of vehicles 2 having matching communication demands is determined using the communication demand information and a matching condition. The matching condition is a condition under which determination is made that communication demands of two vehicles 2 match each other. The communication demand information and the matching condition vary depending on use cases of processes to be arbitrated by the arbitration system 100, that is, authentication processes for vehicle-to-vehicle wireless LAN communication in the first embodiment. Two use cases will be described below as examples.

### Use Case 1

Use case 1 is a use case where, for example, software update data, map data, etc. is shared between vehicles 2 by vehicle-to-vehicle wireless LAN communication. In use case 1, some vehicles 2 hold data downloaded from a data center using cellular communication, wireless LAN communication, etc., and when passing other vehicles 2, distribute the data to the other passing vehicles 2 by vehicle-to-vehicle wireless LAN communication. In use case 1, before the data is distributed, authentication for vehicle-to-vehicle wireless LAN communication occurs between two passing vehicles 2. In the authentication process for the vehicle-to-vehicle wireless LAN, one of the vehicle 2 that distributes the data and the vehicle 2 that receives the distributed data operates as the AP vehicle and the other operates as the CL vehicle. The vehicle 2 that distributes the data may be the AP vehicle and the vehicle 2 that receives the distributed data may be the CL vehicle, or vice versa.

In use case 1, examples of the communication demand information transmitted from the vehicle 2 to the management server 1 include information indicating that the vehicle 2 is expected to distribute predetermined data, and information indicating that the vehicle 2 is expected to download data. Examples of the information indicating that the vehicle 2 is expected to distribute predetermined data include a list of distribution target data held by the vehicle 2. The list of distribution target data held by the vehicle 2 includes, for example, identification information of the data and the data size. Examples of the information indicating that the vehicle 2 is expected to download data include a list of data to be downloaded. The list of data to be downloaded by the vehicle 2 includes, for example, identification information of the data, a time limit for completion of the download, and a priority level. The priority level indicates the order of download.

In use case 1, the matching condition is, for example, that data to be downloaded by one vehicle 2 is included in data held by the other vehicle 2. The matching condition in use case 1 is not limited to this. For example, a pair of vehicles 2 having matching communication demands may be given a priority level for arbitration of the authentication process based on the priority level of the order of download of data to be distributed or the time limit for completion of the download. More specifically, a higher priority level may be given to a pair of vehicles 2 so that the pair of vehicles 2 is prioritized for arbitration of the authentication process as the priority level of the order of download of data to be distributed between the vehicles 2 increases. For example, a higher priority level may be given to the pair of vehicles 2 as the time limit for completion of the download of the data to be distributed between the vehicles 2 is closer.

### Use Case 2

Use case 2 is a use case where, for example, sensor data generated by the vehicle 2 is uploaded to a remote server disposed on a cloud etc. Instead of each vehicle 2 uploading data directly to the remote server using cellular communication etc., sensor data is aggregated in some of the vehicles 2 by vehicle-to-vehicle wireless LAN communication, and the vehicles 2 transmit the aggregated sensor data to the remote server by cellular communication or via nearby Wi-Fi access points while the vehicles are stopped. In use case 2, for example, before sensor data generated by a vehicle 2 is transmitted to a vehicle 2 in which the sensor data will be aggregated, authentication for vehicle-to-vehicle wireless LAN communication occurs between the vehicle 2 that has generated the sensor data and the vehicle 2 in which the sensor data will be aggregated. The vehicle 2 that aggregates the sensor data may execute a predetermined process on the sensor data collected from other vehicles 2 and then transmit it to the remote server. In use case 2, for example, the frequency of cellular communication between the remote server and the vehicle 2 can be reduced.

In use case 2, examples of the communication demand information transmitted from the vehicle 2 to the management server 1 include information indicating that the vehicle 2 is expected to upload predetermined data, and information of the vehicle 2 about a requirement for the data aggregation destination. Examples of the information indicating that the vehicle 2 is expected to upload predetermined data include a list of data to be uploaded by the vehicle 2. The list of data to be uploaded by the vehicle 2 includes, for example, a data ID, a data type, a time limit for completion of the upload, and a priority level of the upload for the data to be uploaded.

Examples of the requirement for the vehicle 2 to operate as the data aggregation destination include a requirement that the remaining storage capacity is equal to or larger than a threshold, a requirement that the vehicle 2 is connectable to a Wi-Fi access point, and a requirement that the vehicle 2 can execute a predetermined process on collected data. The phrase “connectable to a Wi-Fi access point” means, for example, that the vehicle 2 has a function (such as software) for connection to a Wi-Fi access point. The phrase “can execute a predetermined process on collected data” means, for example, that the resources of the vehicle 2 are sufficient to execute the predetermined process. Examples of the resources of the vehicle 2 include a processor, a memory, a storage, and a network bandwidth of an in-vehicle device or any other electronic control unit (ECU) mounted on the vehicle 2.

When the requirement for the vehicle 2 to operate as the data aggregation destination is as described above, examples of the information of the vehicle 2 about the requirement for the data aggregation destination that is one of the communication demand conditions include the remaining storage capacity of the vehicle 2, the connectivity to a Wi-Fi access point, and the executability of the predetermined process on collected data. The information to be used as the communication demand information in use case 2 is not limited to the above.

In use case 2, the matching condition is, for example, that one vehicle 2 has data to be uploaded and the other vehicle 2 meets the requirement for the data aggregation destination. The matching condition in use case 2 is not limited to this. For example, a pair of vehicles 2 having matching communication demands may be given a priority level for arbitration of the authentication process based on the priority level of the order of upload of data or the time limit for completion of the upload. More specifically, a higher priority level may be given to a pair of vehicles 2 so that the pair of vehicles 2 is prioritized for arbitration of the authentication process as the priority level of the order of upload of data to be aggregated between the vehicles 2 increases. For example, a higher priority level may be given to the pair of vehicles 2 as the time limit for completion of the upload of the data to be aggregated between the vehicles 2 is closer.

The arbitration system 100 may be configured to handle one use case or to handle a plurality of use cases. When the arbitration system 100 is configured to handle a plurality of use cases, the management server 1 holds in advance settings of the communication demand information and the matching condition associated with each use case. The use cases that can be handled by the arbitration system 100 are not limited to the above two cases. The functional configuration of the management server 1 is not limited to the functional configuration shown in FIG. 3.

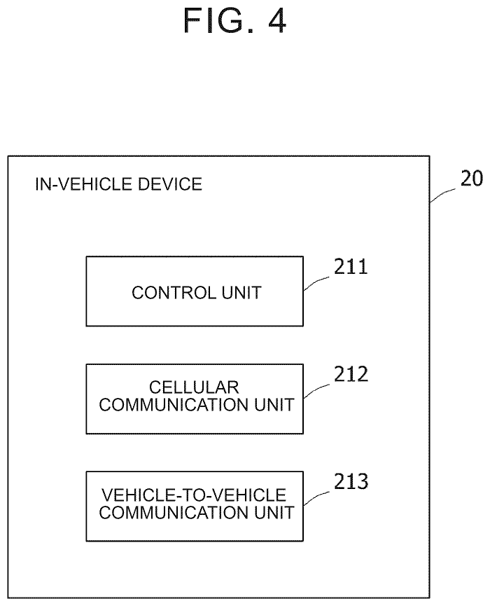

FIG. 4 is a diagram showing an example of a functional configuration of an in-vehicle device 20 mounted on the vehicle 2. The hardware configuration of the in-vehicle device 20 includes, for example, a processor, a memory, an auxiliary storage device, and a communication unit similarly to the management server 1 shown in FIG. 2. The in-vehicle device 20 may include a plurality of communication units such as a communication unit for vehicle-to-vehicle wireless LAN communication and a communication unit for cellular communication.

The in-vehicle device 20 includes a control unit 211 as the functional configuration. The control unit 211 generates movement information and communication demand information periodically at the predetermined cycle, and transmits them to the management server 1 via a cellular communication unit 212. The control unit 211 receives an instruction to execute the advance preparation process from the management server 1 via the cellular communication unit 212. In the first embodiment, when the instruction to execute the advance preparation process is received from the management server 1, the control unit 211 executes the authentication key acquisition process (initial authentication process) for vehicle-to-vehicle wireless LAN communication as the advance preparation process. The control unit 211 executes the authentication key acquisition process (initial authentication process) for vehicle-to-vehicle wireless LAN communication with the paired vehicle 2 via the cellular communication unit 212. The control unit 211 acquires a re-authentication root key in the initial authentication process, and stores (caches) the re-authentication root key in a temporary storage area in the auxiliary storage device 103 accessible to a vehicle-to-vehicle communication unit 213.

The cellular communication unit 212 controls cellular communication. When data is received from the control unit 211, the cellular communication unit 212 outputs the data to a cellular network via the communication unit for cellular communication (hardware component). When data is received from the cellular network via the communication unit for cellular communication (hardware component), the cellular communication unit 212 outputs the data to the control unit 211.

The vehicle-to-vehicle communication unit 213 controls vehicle-to-vehicle communication. In the first embodiment, the vehicle-to-vehicle communication unit 213 controls vehicle-to-vehicle wireless LAN communication. When data is received from the control unit 211, the vehicle-to-vehicle communication unit 213 outputs the data to a communication partner of vehicle-to-vehicle communication via the communication unit for vehicle-to-vehicle communication (hardware component). When data is received via the communication unit for vehicle-to-vehicle communication (hardware component), the vehicle-to-vehicle communication unit 213 outputs the data to the control unit 211.

When the vehicle-to-vehicle communication unit 213 operates as the AP vehicle, the vehicle-to-vehicle communication unit 213 operates as the authentication server. When the vehicle-to-vehicle communication unit 213 operates as the AP vehicle and a connection request is received from the CL vehicle by vehicle-to-vehicle wireless LAN communication, the vehicle-to-vehicle communication unit 213 executes the authentication process as the authentication server, and is connected to the CL vehicle to execute vehicle-to-vehicle wireless LAN communication. When the vehicle-to-vehicle communication unit 213 operates as the CL vehicle and the AP vehicle is detected by receiving a beacon signal transmitted from the AP vehicle, the vehicle-to-vehicle communication unit 213 transmits a connection request to the AP vehicle by vehicle-to-vehicle wireless LAN communication, executes the authentication process, and is connected to the AP vehicle to execute vehicle-to-vehicle wireless LAN communication. Whether the vehicle-to-vehicle communication unit 213 operates as the AP vehicle or the CL vehicle is, for example, designated in advance by the management server 1. Regardless of whether the vehicle-to-vehicle communication unit 213 is the AP vehicle or the CL vehicle, the initial authentication process is executed when the re-authentication root key with the partner of the authentication process is not cached, and the authentication process is executed using the re-authentication root key with the partner of the authentication process when the re-authentication root key is cached. The functional configuration of the in-vehicle device 20 is not limited to the example shown in FIG. 4.

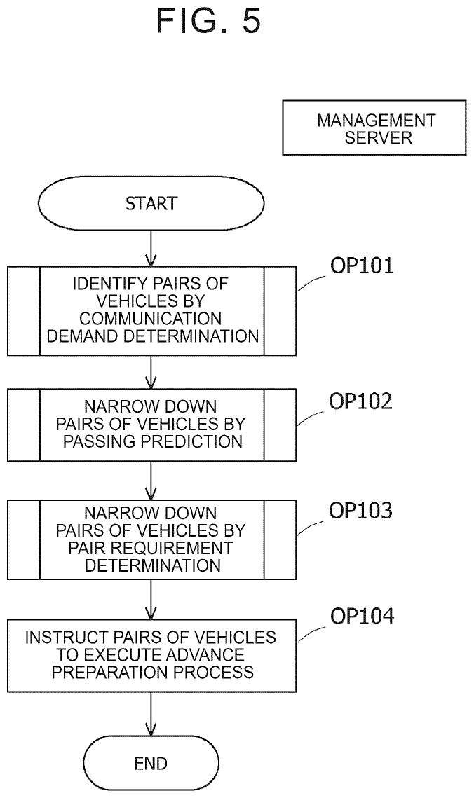

FIG. 5 is an example of a flowchart of a process in the management server 1 according to the first embodiment. The process shown in FIG. 5 is repeatedly executed, for example, at a predetermined cycle. Although the process shown in FIG. 5 is executed by a hardware component such as the processor 101, description will be given under the assumption that the process is executed by functional components for convenience.

In OP101, the prediction unit 11 executes communication demand determination on a plurality of vehicles 2 in a predetermined area based on pieces of communication demand information, and identifies a plurality of pairs of vehicles 2 having matching communication demands. The prediction unit 11 may identify a plurality of pairs for one vehicle 2. The predetermined area is, for example, a range larger than the communication range of vehicle-to-vehicle wireless LAN communication.

In OP102, the prediction unit 11 executes passing prediction for each of the pairs of vehicles 2 identified in OP101, and narrows down the pairs of vehicles 2 that are likely to pass each other. In OP103, the prediction unit 11 executes pair requirement determination for each of the pairs of vehicles 2 narrowed down in OP102, and further narrows down the pairs of vehicles 2 that meet the pair requirement. In the first embodiment, the pair requirement is that the AP vehicle and the CL vehicle are paired. In the first embodiment, one or more pairs of AP and CL vehicles that have matching communication demands and are likely to pass each other within the predetermined period in the future are obtained by the process from OP101 to OP103.

When a plurality of pairs is present for one vehicle 2 after the process in OP103, the prediction unit 11 may randomly select one pair. Alternatively, the prediction unit 11 may select a pair having a high priority level based on the priority level of data to be distributed or uploaded between the paired vehicles 2 or the time limit for completion of the download or upload. Alternatively, the prediction unit 11 may select a pair that is most likely to pass each other. Thus, it is possible to reduce the number of pairs for the advance preparation process, thereby reducing, for example, communications via the cellular network.

The present disclosure is not limited to this, and all the pairs for one vehicle 2 present after the process in OP103 may be employed. The identified pair of vehicles 2 will not necessarily pass each other, that is, will not necessarily approach each other at the distance required for vehicle-to-vehicle wireless LAN communication. Therefore, it is possible to suppress missing of the advance preparation process as the number of pairs of vehicles 2 increases.

In OP104, the arbitration unit 12 transmits an instruction to execute the advance preparation process to each of the one or more pairs of vehicles 2 identified by the process from OP101 to OP103. Then, the process shown in FIG. 5 is terminated.

The process in the management server 1 shown in FIG. 5 is an example, and the process in the management server 1 is not limited to the process shown in FIG. 5. For example, the processes of communication demand determination, passing prediction, and pair requirement determination may be executed in any order. The process shown in FIG. 5 is executed for a plurality of vehicles 2 in the predetermined area, but may be executed for each vehicle 2 individually.

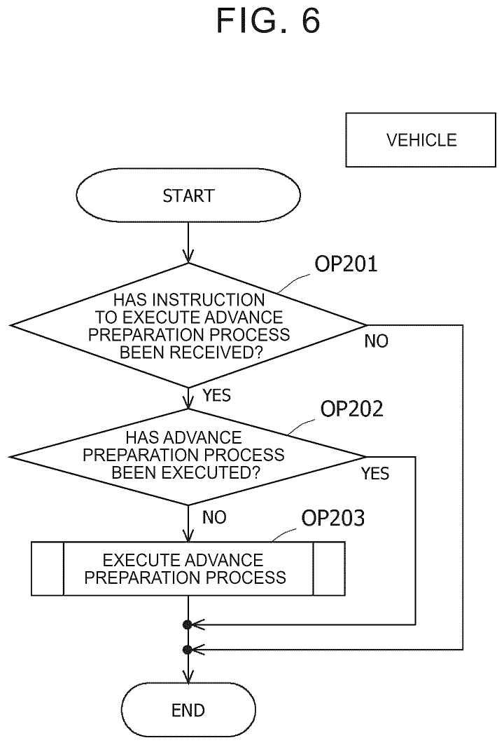

FIG. 6 is an example of a flowchart of a process in the vehicle 2 when an instruction to execute the advance preparation process is received. The process shown in FIG. 6 is repeatedly executed at a predetermined cycle. Although the process shown in FIG. 6 is executed by a hardware component such as the processor, description will be given under the assumption that the process is executed by functional components for convenience. The same applies to the following flowcharts of processes in the vehicle 2.

In OP201, the control unit 211 determines whether an instruction to execute the advance preparation process is received from the management server 1. When the instruction to execute the advance preparation process is received from the management server 1 (OP201: YES), the process proceeds to OP202. When the instruction to execute the advance preparation process is not received (OP201: NO), the process shown in FIG. 6 is terminated.

In OP202, the control unit 211 determines whether the advance preparation process has been executed. In the first embodiment, the advance preparation process is the authentication key acquisition process. Therefore, it is possible to determine that the advance preparation process has been executed based on the fact that a re-authentication root key is cached for the paired vehicle 2. It is possible to determine that the advance preparation process has not been executed based on the fact that the re-authentication root key is not cached for the paired vehicle 2.

When the advance preparation process has been executed (OP202: YES), the process shown in FIG. 6 is terminated. When the advance preparation process has not been executed (OP202: NO), the process proceeds to OP203.

In OP203, the control unit 211 executes the advance preparation process. In the first embodiment, the re-authentication root key is cached by executing the authentication key acquisition process (initial authentication process) with the paired vehicle 2 as the advance preparation process. Then, the process shown in FIG. 6 is terminated.

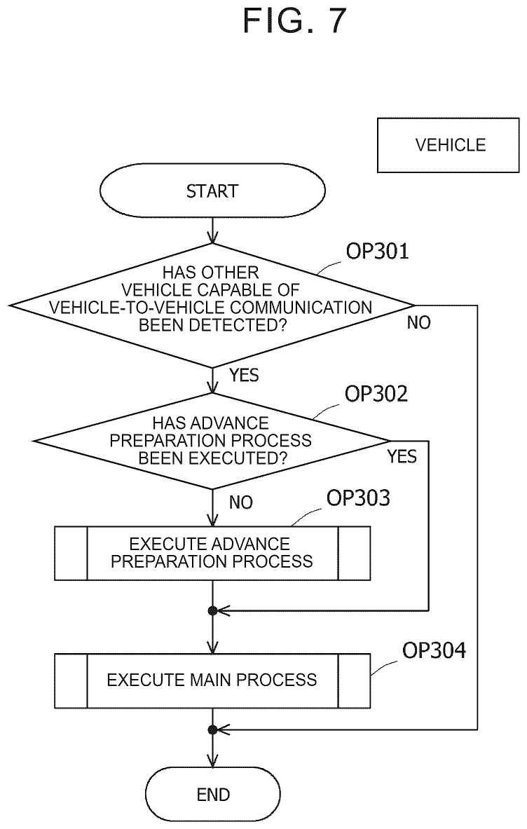

FIG. 7 is an example of a flowchart of a process for starting vehicle-to-vehicle communication between vehicles 2. The process shown in FIG. 7 is repeatedly executed while the vehicle 2 is not executing vehicle-to-vehicle communication and a demand for vehicle-to-vehicle communication occurs.

In OP301, the control unit 211 determines whether another vehicle 2 capable of vehicle-to-vehicle communication is detected. For example, when the vehicle 2 is the CL vehicle, the vehicle 2 detects the AP vehicle by searching for the AP vehicle or receiving a beacon signal from the AP vehicle. When the vehicle 2 is the AP vehicle, the vehicle 2 detects the CL vehicle, for example, by receiving a connection request from the CL vehicle.

When another vehicle 2 capable of vehicle-to-vehicle communication is detected (OP301: YES), the process proceeds to OP302. When another vehicle 2 capable of vehicle-to-vehicle communication is not detected (OP301: NO), the process shown in FIG. 7 is terminated.

In OP302, the control unit 211 determines whether the advance preparation process has been executed. When the advance preparation process has been executed (OP302: YES), the process proceeds to OP304. When the advance preparation process has not been executed (OP302: NO), the process proceeds to OP303.

In OP303, the control unit 211 executes the advance preparation process. In the first embodiment, the advance preparation process is the authentication key acquisition process. In OP304, the control unit 211 executes the main process. In the first embodiment, the main process is the authentication process using the authentication key. Then, the process shown in FIG. 7 is terminated.

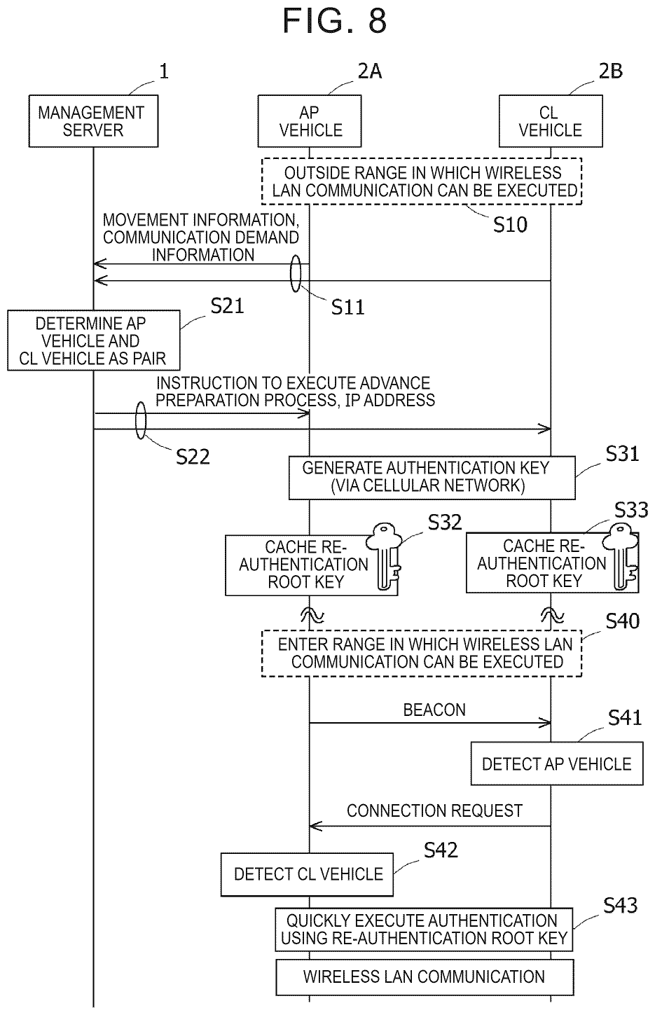

FIG. 8 is an example of a processing sequence when the arbitration system 100 according to the first embodiment arbitrates the authentication process for vehicle-to-vehicle wireless LAN communication. In FIG. 8, it is assumed that the vehicle 2A is the AP vehicle and the vehicle 2B is the CL vehicle. It is also assumed that the vehicles 2A and 2B have not previously executed vehicle-to-vehicle wireless LAN communication and have not cached a re-authentication root key.

In S10, the vehicles 2A and 2B are located outside the range in which vehicle-to-vehicle wireless LAN communication can be executed. In S11, the vehicles 2A and 2B each transmit movement information and communication demand information to the management server 1 periodically at the predetermined cycle, for example, by cellular communication.

In S21, the management server 1 determines the AP vehicle 2A and the CL vehicle 2B as a pair based on the movement information and the communication demand information from each vehicle 2 (OP101 to OP103 in FIG. 5). In S22, the management server 1 transmits an instruction to execute the advance preparation process to the AP vehicle 2A and the CL vehicle 2B determined as a pair (OP104 in FIG. 5). An IP address of the paired vehicle is transmitted together with the instruction to execute the advance preparation process.

In S31, the AP vehicle 2A and the CL vehicle 2B receive the instruction to execute the advance preparation process from the management server 1, and execute the authentication key acquisition process (initial authentication process) as the advance preparation process by cellular communication (FIG. 6). In S32 and S33, the AP vehicle 2A and the CL vehicle 2B each cache a re-authentication root key.

In S40, the AP vehicle 2A and the CL vehicle 2B each move and enter the range in which vehicle-to-vehicle wireless LAN communication can be executed. In S41, for example, a beacon signal transmitted by the AP vehicle 2A reaches the CL vehicle 2B, and the CL vehicle 2B detects that vehicle-to-vehicle wireless LAN communication with the AP vehicle 2A can be executed (OP301 in FIG. 7). For example, the CL vehicle 2B transmits a connection request for vehicle-to-vehicle wireless LAN communication to the AP vehicle 2A. In S42, the AP vehicle 2A receives the connection request for vehicle-to-vehicle wireless LAN communication from the CL vehicle 2B, and detects that vehicle-to-vehicle wireless LAN communication with the CL vehicle 2B can be executed (OP301 in FIG. 7).

Since the re-authentication root key is cached in each of the AP vehicle 2A and the CL vehicle 2B (OP302 in FIG. 7: YES), the AP vehicle 2A and the CL vehicle 2B quickly execute the authentication process using the cached re-authentication root key in S43. When the authentication is successful, the AP vehicle 2A and the CL vehicle 2B can execute vehicle-to-vehicle wireless LAN communication to, for example, distribute or upload data from one vehicle to the other.

### Functions and Effects of First Embodiment

In the first embodiment, the management server 1 creates a pair of vehicles 2 that is located outside the range in which vehicle-to-vehicle wireless LAN communication can be executed and that is predicted to pass each other in the near future, and causes the pair of vehicles 2 to execute initial authentication in advance and cache the re-authentication root key. When the paired vehicles 2 then pass each other, authentication can quickly be executed using the cached re-authentication root key, and the paired vehicles 2 can quickly start vehicle-to-vehicle wireless LAN communication. By reducing the period required for authentication in the limited period in which the paired vehicles 2 pass each other, the period available for data transfer can be increased and the amount of data that can be transmitted by vehicle-to-vehicle wireless LAN communication can be increased.

In the first embodiment, the AP vehicle includes the authentication server. When the initial authentication has been executed in advance, the paired vehicles 2 can execute authentication using the cached re-authentication root key and can quickly start vehicle-to-vehicle wireless LAN communication even if there is no history of passing the paired vehicle 2 or even if the paired vehicles 2 pass each other for the first time at a location outside the cellular communication range.

### Modification of First Embodiment

In the first embodiment, vehicle-to-vehicle wireless LAN communication is executed between the vehicles 2, but the communication between the vehicles 2 is not limited to the vehicle-to-vehicle wireless LAN communication. The communication between the vehicles 2 may be any type of vehicle-to-vehicle communication other than the vehicle-to-vehicle wireless LAN communication as long as it employs an authentication method that can simplify the authentication process using a cached authentication key.

In the first embodiment, cellular communication is executed between the management server 1 and the vehicle 2, but the communication between the management server 1 and the vehicle 2 is not limited to the cellular communication. In addition to the cellular communication, the communication between the management server 1 and the vehicle 2 may be communication conforming to 802.11ah (Wi-Fi HaLow), low power wide area (LPWA) communication, satellite communication, etc.

In the first embodiment, the management server 1 is disposed on the cloud, but the present disclosure is not limited to this. The management server 1 may be disposed, for example, on each vehicle 2. When the management server 1 is disposed on each vehicle 2, the vehicles 2 may communicate directly with each other to notify each other about movement information and communication demand information. The vehicle-to-vehicle communication that is used for transmitting the movement information and the communication demand information is different from the vehicle-to-vehicle wireless LAN communication to be arbitrated, and is communication using the vehicle-to-vehicle communication scheme having a longer communication distance than that of the vehicle-to-vehicle wireless LAN communication. Examples of the vehicle-to-vehicle communication having a longer communication distance than that of the vehicle-to-vehicle wireless LAN communication include Wi-Fi HaLow and cellular device-to-device (D2D) relay communication. When the management server 1 is disposed on each vehicle 2, the management server 1 may identify another vehicle 2 to be paired with the host vehicle by executing passing prediction, communication demand determination, and pair requirement determination for the host vehicle.

When the management server 1 is disposed on each vehicle 2 and movement information etc. are transmitted between the vehicles 2 by vehicle-to-vehicle communication having a longer communication distance than that of the vehicle-to-vehicle wireless LAN communication, it is possible to identify the paired vehicle 2 and execute the authentication key acquisition process with this vehicle 2 before the vehicles 2 enter the range of the distance required for the vehicle-to-vehicle wireless LAN communication.

In the first embodiment, the prediction unit 11 and the arbitration unit 12 are implemented by the same device, but may be disposed in different devices separately. For example, the prediction unit 11 may be disposed in each vehicle 2, and the arbitration unit 12 may be disposed in a server on the cloud. In this case, the arbitration unit 12 collects and transfers movement information and communication demand information from each vehicle 2. Communication is executed between the vehicle 2 and the server including the arbitration unit 12, for example, by cellular communication, Wi-Fi HaLow, LPWA communication, or satellite communication. The arbitration unit 12 receives movement information and communication demand information from each vehicle 2, and transfers the movement information and the communication demand information to each vehicle 2. Thus, the vehicle 2 can identify another vehicle 2 to be paired with the vehicle 2 by executing passing prediction, communication demand determination, and pair requirement determination for the vehicle 2. The vehicle 2 notifies the arbitration unit 12 about the pair of the vehicle 2 and the other vehicle 2, and the arbitration unit 12 transmits an instruction to execute advance preparation to the paired vehicles 2, thereby executing initial authentication between the paired vehicles 2. The initial authentication between the paired vehicles 2 is executed via the arbitration unit 12.

In the first embodiment, the communication demand determination, the passing prediction, and the pair requirement determination are executed to identify a pair of vehicles 2 to be instructed to execute the advance preparation process, but these three processes need not essentially be executed. For example, at least one of the communication demand determination, the passing prediction, and the pair requirement determination may be executed, or none of them may be executed. When none of the communication demand determination, the passing prediction, and the pair requirement determination is executed, all pairs of vehicles 2 located within the predetermined area at a distance longer than the distance required for vehicle-to-vehicle communication may be instructed to execute the advance preparation process. When the communication demand determination, the passing prediction, and the pair requirement determination are executed, it is possible to narrow down and identify pairs of vehicles 2 that are more likely to execute vehicle-to-vehicle communication when passing each other.

### Examples of Arbitration of Other Processes by Arbitration System 100

In the first embodiment, the arbitration system 100 arbitrates the authentication process for vehicle-to-vehicle wireless LAN communication, but the process to be arbitrated by the arbitration system 100 is not limited to the authentication process for vehicle-to-vehicle wireless LAN communication. Examples of the process to be arbitrated by the arbitration system 100 include, in addition to the authentication processes for vehicle-to-vehicle wireless LAN communication, a vehicle-to-vehicle data distribution process and an upload data aggregation process. The process to be arbitrated by the arbitration system 100 is not limited to these. The arbitration system 100 may arbitrate a plurality of types of processes.

### Arbitration of Vehicle-to-Vehicle Data Distribution Process

The vehicle-to-vehicle data distribution process is a process in which a vehicle #X that holds distribution data distributes the distribution data to another vehicle #Y by vehicle-to-vehicle communication. When the arbitration system 100 arbitrates the vehicle-to-vehicle data distribution process, the advance preparation process may be different, for example, between the vehicle #X that distributes data and the vehicle #Y that receives the distributed data. The advance preparation process for the vehicle #X that distributes data is, for example, one or more of download of distribution data from a remote server, fragmentation of the distribution data, and compression of the distribution data. The advance preparation process for the vehicle #Y that receives the distributed data is, for example, securing of a storage area for storing the distribution data. When no advance preparation is required on the vehicle #Y that receives the distributed data, the instruction to execute the advance preparation process may be transmitted only to the vehicle #X that distributes the data. However, at least information on the paired vehicle 2 (e.g., an IP address) is transmitted to each of the vehicle #X that distributes the data and the vehicle #Y that receives the distributed data.

When the arbitration system 100 arbitrates the vehicle-to-vehicle data distribution process, the main process is a data distribution process between the paired vehicles 2. When the vehicle #X that distributes the data and the vehicle #Y that receives the distributed data are close enough to execute vehicle-to-vehicle communication and connection for the vehicle-to-vehicle communication is established between the vehicle #X and the vehicle #Y, the vehicle #X can immediately transmit the distribution data to the vehicle #Y without advance preparation. When the arbitration system 100 arbitrates the vehicle-to-vehicle data distribution process, the communication between the vehicle #X that distributes the data and the vehicle #Y that receives the distributed data is not limited to the vehicle-to-vehicle wireless LAN communication.

When the arbitration system 100 arbitrates the vehicle-to-vehicle data distribution process, the communication demand information and the matching condition are similar to those in use case 1 in the first embodiment. The pair requirement is that one vehicle distributes data and the other vehicle receives the distributed data. Since this is met by the communication demand determination, the pair requirement determination may be omitted when the arbitration system 100 arbitrates the vehicle-to-vehicle data distribution process.

### Arbitration of Upload Data Aggregation Process

The upload data aggregation process is a process in which a vehicle #M that aggregates data receives data by vehicle-to-vehicle communication from a plurality of vehicles #S that holds data to be uploaded. The vehicle #M uploads the aggregated data to a predetermined server by cellular communication etc. When the arbitration system 100 arbitrates the upload data aggregation process, the advance preparation process may be different, for example, between the vehicle #S that holds upload data and the vehicle #M that aggregates data. The advance preparation process to be executed by the vehicle #S that holds upload data is, for example, data format conversion and statistical data processing to be executed by the vehicle #S that holds upload data. The advance preparation process for the vehicle #M that aggregates data is, for example, securing of a storage area for storing upload data. When no advance preparation is required on the vehicle #M that aggregates data, the instruction to execute the advance preparation process may be transmitted only to the vehicle #S that holds upload data. However, at least information on the paired vehicle (e.g., an IP address) is transmitted to each of the vehicle #M and the vehicle #S.

When the arbitration system 100 arbitrates the upload data aggregation process, the main process is a process of transmitting the upload data by vehicle-to-vehicle communication from the vehicle #S that holds the upload data to the vehicle #M that aggregates the data. When the vehicle #S that holds the data and the vehicle #M that aggregates the data are close enough to execute vehicle-to-vehicle communication and connection for the vehicle-to-vehicle communication is established between the vehicle #S and the vehicle #M, the vehicle #S can immediately transmit the upload data to the vehicle #M without advance preparation. The communication between the vehicle #S that holds the data and the vehicle #M that aggregates the data is not limited to the vehicle-to-vehicle wireless LAN communication.

When the arbitration system 100 arbitrates the upload data aggregation process, the communication demand information and the matching condition are similar to those in use case 2 in the first embodiment. The pair requirement is that one vehicle holds upload data and the other vehicle aggregates the data. Since this is met by the communication demand determination, the pair requirement determination may be omitted when the arbitration system 100 arbitrates the upload data aggregation process.

### Second Embodiment

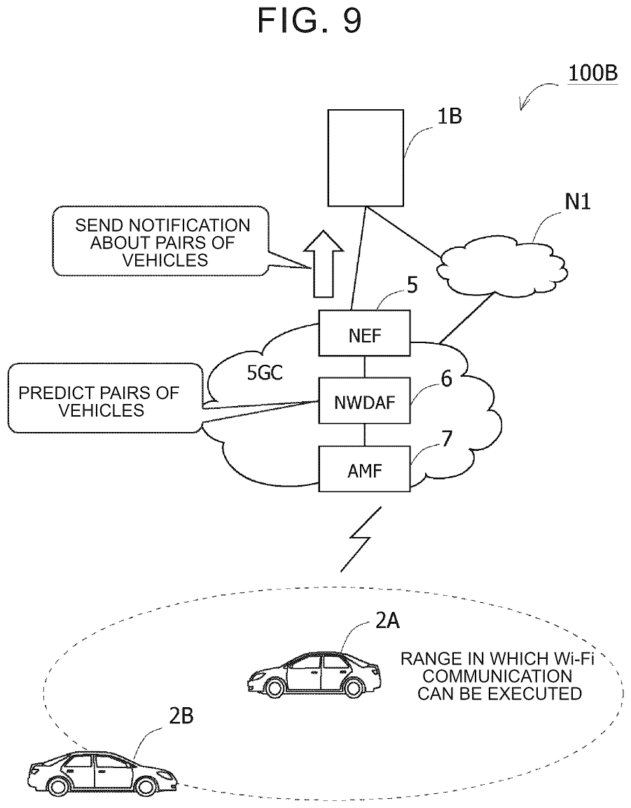

FIG. 9 is a diagram showing an example of a system configuration of an arbitration system 100B according to a second embodiment. In the second embodiment, the arbitration system 100B includes a management server 1B and a plurality of vehicles 2. In the second embodiment, description overlapping with that of the first embodiment will be omitted.

In the second embodiment, each vehicle 2 is connected to a 5G cellular network and to the network N1 via the 5G cellular network, and communicates with the management server 1B via the network N1. A 5G core network transmits and receives control messages to and from the vehicles 2 on a control plane to manage information on the mobility of the vehicles 2. The 5G core network includes a network exposure function (NEF) 5 that is a function of disclosing information to the outside, and a network data analytics function (NWDAF) 6 that is a function of providing analytical information on the network status. The NWDAF 6 also has a function of predicting movement of user equipment (UE) during a designated period. In the second embodiment, the function of the NWDAF 6 in the 5G core network is used to provide the NWDAF 6 with the function of passing prediction. The management server 1B receives a notification from the 5G core network about pairs of vehicles 2 identified by the passing prediction, and executes communication demand determination and pair requirement determination for the pairs of vehicles 2 in the notification to identify a pair of vehicles 2 to be caused to execute the advance preparation process.

In the second embodiment, each vehicle 2 does not transmit a message specific to the arbitration system 100B as the movement information to the management server 1B as in the first embodiment. In the second embodiment, the NWDAF 6 that executes the passing prediction predicts the movement of the UE based on information related to a tracking area (TA) or cell where the UE is located and acquired as UE location information from an access and mobility management function (AMF) 7 that manages the mobility of the UE. In the second embodiment, the movement information of the vehicle 2 corresponds to the information related to the TA or cell where the vehicle 2 is located and acquired from the AMF 7 by the NWDAF 6. The TA or cell where the vehicle 2 is located is grasped by the AMF 7, for example, when the vehicle 2 registers the TA or cell in the AMF 7 or when the vehicle 2 updates the registration in response to movement to the outside of the current registration area. Alternatively, the TA or cell where the vehicle 2 is located is grasped by an access network node (e.g., a gNB) to which the vehicle 2 is connected, and the AMF 7 is notified about the TA or cell.

In the second embodiment, when the management server 1B receives a notification from the 5G core network about pairs of vehicles 2 that are likely to pass each other within the predetermined period in the future, the management server 1B executes the communication demand determination and the pair requirement determination for the pairs of vehicles 2 in the notification to narrow down the pairs of vehicles 2 and identify a pair of vehicles 2 to be caused to execute the advance preparation process. Then, an instruction to execute advance preparation is transmitted to the identified pair of vehicles 2.

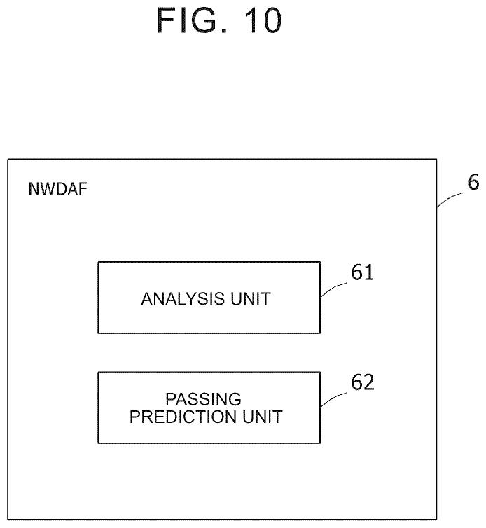

FIG. 10 is an example of a functional configuration of the NWDAF 6 according to the second embodiment. Each network function (NF) in the 5G core network including the NWDAF 6 is, for example, an instance disposed on an information processing device as a virtual machine. The hardware configuration of the information processing device including the NF includes a processor, a memory, an auxiliary storage device, and a communication unit similarly to the hardware configuration of the management server 1.

The NWDAF 6 includes an analysis unit 61 and a passing prediction unit 62 as the functional configuration. In the second embodiment, the analysis unit 61 acquires pieces of movement information of the vehicles 2 from the AMF 7 and predicts the movement of each vehicle 2 within a predetermined period. Based on the result of the prediction of the movement of each vehicle 2 by the analysis unit 61, the passing prediction unit 62 identifies pairs of vehicles 2 that are likely to pass each other within the predetermined period, that is, likely to be close enough to execute vehicle-to-vehicle communication. The passing prediction method is as described in the first embodiment. The passing prediction unit 62 notifies the management server 1B about the pairs of vehicles 2 that are likely to pass each other within the predetermined period. The functional configuration of the NWDAF 6 shown in FIG. 10 is an extracted configuration related to the arbitration system 100B, and is not limited to that shown in FIG. 10.

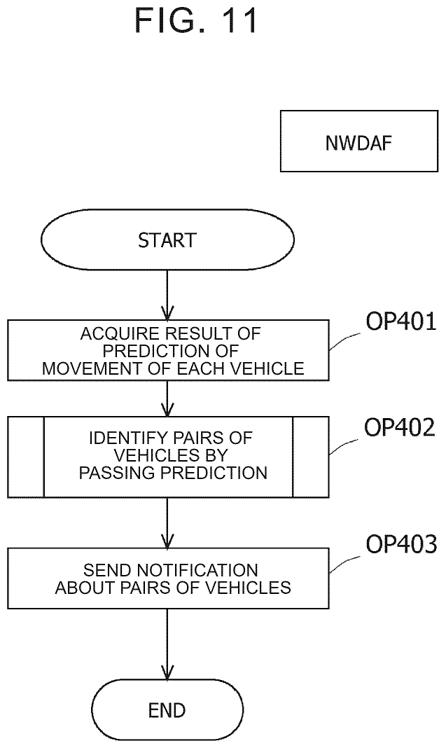

FIG. 11 is an example of a flowchart of passing prediction in the NWDAF 6 according to the second embodiment. The process shown in FIG. 11 is repeatedly executed at a predetermined cycle while the passing prediction is subscribed by the management server 1B.

In OP401, the passing prediction unit 62 acquires a result of prediction of the movement of each vehicle 2 from the analysis unit 61. In OP402, the passing prediction unit 62 executes the passing prediction to identify pairs of vehicles 2 that are likely to pass each other within the predetermined period in the future. In OP403, the passing prediction unit 62 notifies the management server 1B about the identified pairs of vehicles 2. Then, the process shown in FIG. 11 is terminated.

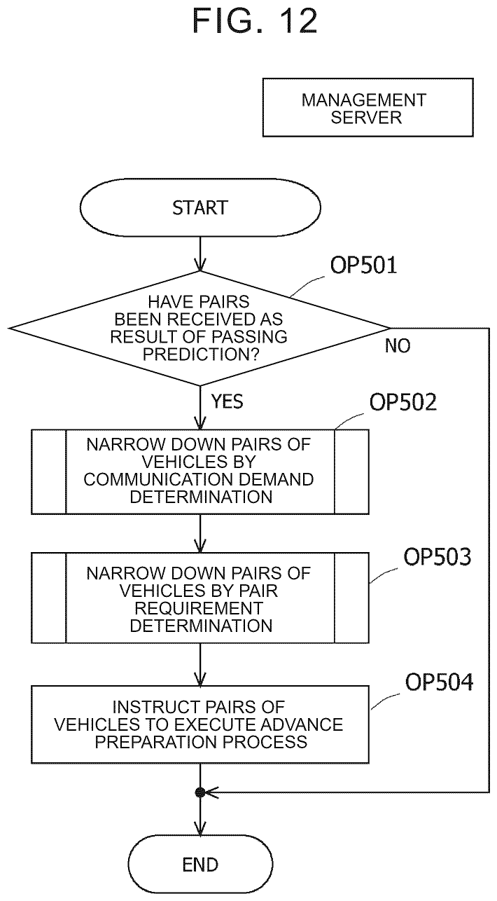

FIG. 12 is an example of a flowchart of a process in the management server 1B according to the second embodiment. The process shown in FIG. 12 is repeatedly executed at a predetermined cycle. In OP501, the prediction unit 11 determines whether a notification about pairs of vehicles 2 identified as a result of the passing prediction is received from the 5G core network. When the notification about pairs of vehicles 2 identified as a result of the passing prediction is received (OP501: YES), the process proceeds to OP502. When the notification about pairs of vehicles 2 identified as a result of the passing prediction is not received (OP501: NO), the process shown in FIG. 12 is terminated.

In OP502, the prediction unit 11 executes the communication demand determination for the pairs of vehicles 2 in the notification from the 5G core network to narrow down the pairs of vehicles 2 having matching communication demands. In P503, the pair requirement determination is executed for the pairs of vehicles 2 narrowed down in OP502 to further narrow down the pairs to pairs of vehicles 2 that meet the pair requirement. In OP504, the arbitration unit 12 transmits an instruction to execute the advance preparation process to each of the pairs of vehicles 2 narrowed down by the process in OP502 and OP503. Then, the process shown in FIG. 12 is terminated. The process in the management server 1B is not limited to the process shown in FIG. 12. For example, the communication demand determination and the pair requirement determination may be executed in reverse order.

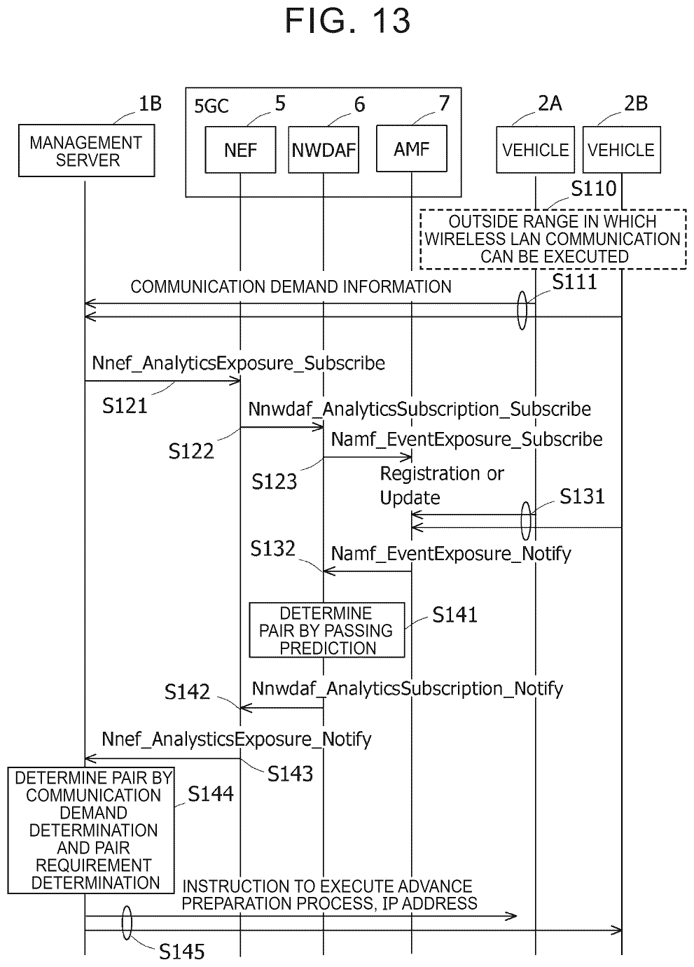

FIG. 13 is a diagram showing an example of a processing sequence to be executed by the arbitration system 100B according to the second embodiment to arbitrate a predetermined process. In FIG. 13, only the NEF 5, the NWDAF 6, and the AMF 7 are shown as the NFs in the 5G core network, but the NFs in the 5G core network are not limited to these. In FIG. 13, it is assumed, similarly to the first embodiment, that the arbitration system 100B arbitrates the authentication process for vehicle-to-vehicle wireless LAN communication.

In S110, the vehicles 2A and 2B are located outside the range in which vehicle-to-vehicle wireless LAN communication can be executed. In S111, the vehicles 2A and 2B each transmit communication demand information to the management server 1B periodically at the predetermined cycle, for example, by cellular communication.

In S121, the management server 1B transmits, to the NEF 5, an Nnef_AnalyticsExposure_Subscribe request message for requesting disclosure of network information and event information. For example, Analytics ID=“UE Mobility” indicating a request for statistics and prediction of UE movement, information indicating a request to create pairs of vehicles 2 (UE) that are likely to pass each other within the predetermined period, a period of the prediction, an ID of a target vehicle 2 (UE) or a group of vehicles 2 (UE group), and a threshold distance for the passing prediction are transmitted together with the Nnef_AnalyticsExposure_Subscribe request message. The Nnef_AnalyticsExposure_Subscribe request message is transmitted by the prediction unit 11 of the management server 1B.

In S122, the NEF 5 receives the Nnef_AnalyticsExposure_Subscribe request message from the management server 1B, converts it into an Nnwdaf_AnalyticsSubscription_Subscribe request message, and transmits it to the NWDAF 6. When the NWDAF 6 receives the Nnwdaf_AnalyticsSubscription_Subscribe request message including the information indicating the request to create pairs of vehicles 2 (UE) that are likely to pass each other within the predetermined period, the NWDAF 6 activates the passing prediction unit 62 and starts, for example, the process shown in FIG. 11.

In S123, the NWDAF 6 transmits, to the AMF 7, an Namf_EventExposure_Subscribe request message for requesting information collection. When an event related to movement management occurs, such as a change in the position of the vehicle 2 (UE), and the AMF 7 detects the event, the NWDAF 6 is notified about information on the event.

In S131, the vehicles 2A and 2B that are targets of the passing prediction execute registration in the 5G system (“Registration”), update the registration when they move and enter a different TA (“Mobility Registration Update”), or periodically update the registration (“Periodic Registration Update TAU Update”). Each vehicle 2 executes the registration in the 5G system and updates the registration, for example, using a non-access stratum (NAS) signaling message.

In S132, the AMF 7 notifies the NWDAF 6 about the events related to the movement of the vehicles 2A and 2B by transmitting an Namf_EventExposure_Notify message. Position information of the vehicle 2A or 2B is transmitted together with the Namf_EventExposure_Notify message. The position information of the vehicle 2 (UE) transmitted together with the Namf_EventExposure_Notify message is an ID of the TA or cell.

In S141, the NWDAF 6 predicts movement routes of the vehicles 2 based on the information collected from the AMF 7 at the predetermined cycle (OP401 in FIG. 11), and executes the passing prediction to identify, in the example shown in FIG. 13, the vehicles 2A and 2B as a pair of vehicles that is likely to pass each other within the designated period (OP402 in FIG. 11). In S142, the NWDAF 6 transmits an Nnwdaf_AnalyticsSubscription_Notify message to the NEF 5. Information on the identified pair of vehicles 2A and 2B is transmitted together with the Nnwdaf_AnalyticsSubscription_Notify message. In S143, the NEF 5 receives the Nnwdaf_AnalyticsSubscription_Notify message from the NWDAF 6, converts it into an Nnef_AnalysticsExposure_Notify message, and transmits it to the management server 1B. The information on the identified pair of vehicles 2A and 2B is transmitted together with the Nnef_AnalysticsExposure_Notify message.

In S144, the management server 1B receives the information on the pair of vehicles 2A and 2B from the NEF 5 as a result of the passing prediction (OP501 in FIG. 12: YES), and executes the communication demand determination and the pair requirement determination for the pair of vehicles 2A and 2B (OP502 and OP503 in FIG. 12). In the example shown in FIG. 13, it is assumed that the vehicles 2A and 2B have matching communication demands and meet the pair requirement. In S145, the management server 1B transmits an instruction to execute the advance preparation process to the vehicles 2A and 2B. An IP address of the paired vehicle is transmitted together with the instruction to execute the advance preparation process. Then, the advance preparation process is executed between the vehicles 2A and 2B as in the sequence in FIG. 8.

In the second embodiment, the functions of the 5G core network are used to identify, by the 5G core network, pairs of vehicles 2 that are likely to pass each other. Thus, the vehicle 2 need not transmit movement information to the arbitration system 100B, thereby reducing band usage in the cellular network.

### Modification of Second Embodiment

An NF having the functions of communication demand determination and pair requirement determination may be added to the 5G core network and, in cooperation with the NWDAF 6, a pair of vehicles 2 to be caused to execute the advance preparation process may be identified by the 5G core network. Alternatively, the functions of communication demand determination and pair requirement determination may be added to the NWDAF 6 in addition to the passing prediction. Alternatively, the management server 1B may be added to the 5G core network as an NF. Any of the cases can be realized when the vehicle 2 transmits the communication demand information to the 5G core network, for example, using the control messages on the control plane of the 5G core network.

### Third Embodiment

In a third embodiment, a management server 1C executes the passing prediction based on a result of prediction of the movement of the vehicles 2 by the 5G core network using the movement prediction function of the 5G core network for the vehicles 2. In the third embodiment, each vehicle 2 does not transmit a message specific to the arbitration system as the movement information to the management server 1C as in the second embodiment. In the third embodiment, the movement information of the vehicle 2 corresponds to the information related to the TA or cell where the vehicle 2 is located and acquired from the AMF 7 by the NWDAF 6, or the result of prediction of the movement of the vehicle 2 by the 5G core network.

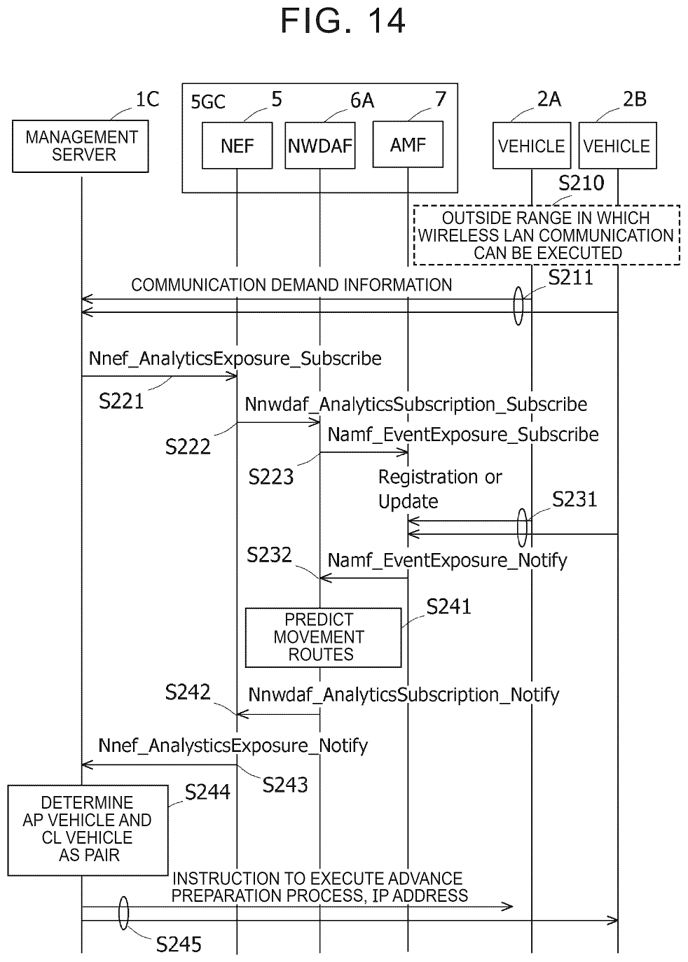

FIG. 14 is a diagram showing an example of a processing sequence to be executed by the arbitration system according to the third embodiment to arbitrate a predetermined process. In FIG. 14, only the NEF 5, the NWDAF 6, and the AMF 7 are extracted as the NFs in the 5G core network as in FIG. 13. In FIG. 14, it is assumed, similarly to the first embodiment, that the arbitration system arbitrates the authentication process for vehicle-to-vehicle wireless LAN communication.

In S210, the vehicles 2A and 2B are located outside the range in which vehicle-to-vehicle wireless LAN communication can be executed. In S211, the vehicles 2A and 2B each transmit communication demand information to the management server 1C periodically at the predetermined cycle, for example, by cellular communication.

In S221, the management server 1C transmits, to the NEF 5, an Nnef_AnalyticsExposure_Subscribe request message for requesting disclosure of network information and event information. For example, Analytics ID=“UE Mobility” indicating a request for statistics and prediction of UE movement, a period of the prediction, and an ID of a target vehicle 2 (UE) or a group of vehicles 2 (UE group) are transmitted together with the Nnef_AnalyticsExposure_Subscribe request message. The Nnef_AnalyticsExposure_Subscribe request message transmitted in S221 may be a request to the 5G core network for the prediction of the movement of the vehicles 2.

In S222, the NEF 5 receives the Nnef_AnalyticsExposure_Subscribe request message from the management server 1C, converts it into an Nnwdaf_AnalyticsSubscription_Subscribe request message, and transmits it to the NWDAF 6. In response to reception of the Nnwdaf_AnalyticsSubscription_Subscribe request message, the NWDAF 6 starts predicting the movement of the designated vehicles 2. In S223, the NWDAF 6 transmits, to the AMF 7, an Namf_EventExposure_Subscribe request message for requesting information collection.

In S231, the vehicles 2A and 2B that are targets of the passing prediction execute registration in the 5G system (“Registration”), update the registration when they move and enter a different TA (“Mobility Registration Update”), or periodically update the registration (“Periodic Registration Update TAU Update”).

In S232, the AMF 7 notifies the NWDAF 6 about the events related to the movement of the vehicles 2A and 2B by transmitting an Namf_EventExposure_Notify message. Position information of the vehicle 2A or 2B is transmitted together with the Namf_EventExposure_Notify message.

In S241, the NWDAF 6 predicts movement routes of the vehicles 2 based on the information collected from the AMF 7 at the predetermined cycle. In S242, the NWDAF 6 transmits an Nnwdaf_AnalyticsSubscription_Notify message to the NEF 5. A result of the prediction of the movement of the vehicles 2 is transmitted together with the Nnwdaf_AnalyticsSubscription_Notify message. In S243, the NEF 5 receives the Nnwdaf_AnalyticsSubscription_Notify message from the NWDAF 6, converts it into an Nnef_AnalysticsExposure_Notify message, and transmits it to the management server 1C.

In S244, the management server 1C receives the result of the prediction of the movement of the vehicles 2 from the NEF 5, and executes the passing prediction, the communication demand determination, and the pair requirement determination based on the result of the prediction of the movement of the vehicles 2 to identify a pair of vehicles 2 for the advance preparation process. In the example shown in FIG. 14, it is assumed that the vehicles 2A and 2B are likely to pass each other, have matching communication demands, and meet the pair requirement, and are therefore identified as a pair for the advance preparation process. In S245, the management server 1C transmits an instruction to execute the advance preparation process to the vehicles 2A and 2B. An IP address of the paired vehicle is transmitted together with the instruction to execute the advance preparation process. Then, the advance preparation process is executed between the vehicles 2A and 2B as in the sequence in FIG. 8.

In the third embodiment, the known 5G core network can be used as it is. The vehicle 2 need not transmit movement information to the management server 1C, thereby reducing band usage in the cellular network.

### OTHER EMBODIMENTS

The above embodiments are merely illustrative, and the present disclosure may be modified as appropriate without departing from the spirit and scope of the present disclosure.

In the first to third embodiments, it is assumed that the arbitration system arbitrates the process related to communication between vehicles, but the present disclosure is not limited to this. The arbitration system may arbitrate a process related to communication between mobile terminals such as smartphones, tablet terminals, wearable terminals, or gaming devices. One side need not be a mobile terminal as in a case of a wireless LAN access point and a mobile terminal.

The processes and means described in the present disclosure can be combined as desired as long as no technical contradiction occurs.

The process described as being executed by a single device may be executed by a plurality of devices in cooperation. Alternatively, the process described as being executed by different devices may be executed by a single device. In a computer system, the hardware configuration (server configuration) that implements functions can be changed flexibly.

The present disclosure may be embodied such that a computer program that implements the functions described in the above embodiments is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any type of disk or disc such as a magnetic disk (floppy (registered trademark) disk, hard disk drive (HDD), etc.) and an optical disc (compact disc (CD) ROM, digital versatile disc (DVD), Blu-ray disc, etc.), a read only memory (ROM), a random access memory (RAM), an EPROM, an electrically erasable programmable ROM (EEPROM), a magnetic card, a flash memory, an optical card, and any type of medium suitable for storing electronic instructions.

What is claimed is:

1. An information processing device comprising a processor configured to:
acquire a pair of a first device and a first terminal predicted to move closer to the first device at a distance shorter than a first distance at which communication is possible using a first communication scheme; and
transmit, to at least either of the first device and the first terminal, an instruction to execute a second process that is an advance preparation process for a first process to be executed by the communication using the first communication scheme when the first device and the first terminal are closer to each other at the distance shorter than the first distance.

2. The information processing device according to claim 1, wherein the processor is configured to:
acquire information on movement of a plurality of terminals including the first terminal; and
acquire the pair of the first device and the first terminal when a distance between the first device and the first terminal is shorter than a second distance longer than the first distance based on the information on the movement of the plurality of terminals.

3. The information processing device according to claim 1, wherein the processor is configured to:
acquire information on movement of at least the first terminal;
calculate a probability that the first device and the first terminal are expected to be closer to each other at the distance shorter than the first distance based on a movement history of at least the first terminal; and
identify the pair of the first device and the first terminal when the probability is equal to or higher than a predetermined threshold.

4. The information processing device according to claim 2, wherein the processor is configured to:
acquire information on a communication demand from at least the first terminal; and
identify the pair of the first device and the first terminal based on information on movement of at least the first terminal and the information on the communication demand.

5. The information processing device according to claim 1, wherein:
the first process is a process in which the first device and the first terminal authenticate, with a predetermined authentication key, connection using the first communication scheme; and
the second process is a process in which the first device and the first terminal each acquire and cache the predetermined authentication key.

6. The information processing device according to claim 1, wherein:
the first process is a process in which one of the first device and the first terminal transmits predetermined data to another; and
the second process is an advance preparation process for transmission of the predetermined data by the one of the first device and the first terminal.

7. The information processing device according to claim 1, wherein the processor is configured to:
transmit a first request for acquisition of the pair to a network data analytics function of a core network of a mobile communication system; and
receive the pair from the network data analytics function.

8. The information processing device according to claim 1, wherein the processor is configured to:
transmit a second request for information on movement of a plurality of terminals to a network data analytics function of a core network of a mobile communication system;
receive the information on the movement of the plurality of terminals from the network data analytics function; and
identify the pair based on the information on the movement of the plurality of terminals.

9. A method comprising:
acquiring, by a first computer out of a plurality of computers, a pair of a first device and a first terminal predicted to move closer to the first device at a distance shorter than a first distance at which communication is possible using a first communication scheme; and
transmitting, by at least one computer out of the plurality of computers, to at least either of the first device and the first terminal, an instruction to execute a second process that is an advance preparation process for a first process to be executed by the communication using the first communication scheme when the first device and the first terminal are closer to each other at the distance shorter than the first distance.

10. The method according to claim 9, wherein the at least one computer out of the plurality of computers is configured to:
acquire information on movement of a plurality of terminals; and
acquire the pair of the first device and the first terminal when a distance between the first device and the first terminal is shorter than a second distance longer than the first distance based on the information on the movement of the plurality of terminals.

11. The method according to claim 9, wherein the at least one computer out of the plurality of computers is configured to:
acquire information on movement of at least the first terminal;
calculate a probability that the first device and the first terminal are expected to be closer to each other at the distance shorter than the first distance based on a movement history of at least the first terminal; and
identify the pair of the first device and the first terminal when the probability is equal to or higher than a predetermined threshold.

12. The method according to claim 10, wherein the at least one computer out of the plurality of computers is configured to:
acquire information on a communication demand from at least the first terminal; and
identify the pair of the first device and the first terminal based on information on movement of at least the first terminal and the information on the communication demand.

13. The method according to claim 9, wherein:
the first process is a process in which the first device and the first terminal authenticate, with a predetermined authentication key, connection using the first communication scheme; and
the second process is a process in which the first device and the first terminal each acquire and cache the predetermined authentication key.

14. The method according to claim 9, wherein:
the first process is a process in which one of the first device and the first terminal transmits predetermined data to another; and
the second process is an advance preparation process for transmission of the predetermined data by the one of the first device and the first terminal.

15. The method according to claim 9, wherein:
the first computer out of the plurality of computers is configured to transmit a first request for acquisition of the pair to a network data analytics function of a core network of a mobile communication system;
the network data analytics function is configured to acquire the pair;
the network data analytics function is configured to transmit the pair to the first computer;
the first computer is configured to receive the pair from the network data analytics function; and
the first computer is configured to transmit the instruction to execute the second process to the at least either of the first device and the first terminal.

16. The method according to claim 9, wherein:
the first computer out of the plurality of computers is configured to transmit a second request for information on movement of a plurality of terminals to a network data analytics function of a core network of a mobile communication system;
the network data analytics function is configured to acquire the information on the movement from the plurality of terminals;
the network data analytics function is configured to transmit the information on the movement of the plurality of terminals to the first computer;
the first computer is configured to receive the information on the movement of the plurality of terminals from the network data analytics function;
the first computer is configured to identify the pair based on the information on the movement of the plurality of terminals; and
the first computer is configured to transmit the instruction to execute the second process to the at least either of the first device and the first terminal.

17. An information processing device comprising a processor configured to:
receive a first request for acquisition of a pair of a first device and a first terminal predicted to move closer to the first device at a distance shorter than a first distance at which communication is possible using a first communication scheme;
identify the pair based on information on movement of the first device and a plurality of terminals; and
transmit information on the identified pair.

18. The information processing device according to claim 17, wherein the processor is configured to:
execute prediction of movement of at least the first terminal within a predetermined period based on the information on the movement of the plurality of terminals; and
acquire the pair of the first device and the first terminal when a distance between the first device and the first terminal is shorter than a second distance longer than the first distance based on a result of the prediction.

19. The information processing device according to claim 17, wherein the information processing device is a network data analytics function of a core network of a mobile communication system.
